(19) United States
(12) Patent Application Publication
(10) Pub. No.: US 2026/0268575 A1
(43) Pub. Date: Sep. 10, 2026

(54) REAL-TIME UPDATEABLE MECHANICALLY ACTUATED SPECULAR HOLOGRAPHIC DISPLAY

(71) Applicant: Lenovo Global Technology (United States) Inc., Morrisville, NC (US)

(72) Inventors: Grason Humphrey, Morrisville, NC (US); Eric Li, Morrisville, NC (US); Michael DeCesaris, Morrisville, NC (US); Milton Cobo, Morrisville, NC (US)

(21) Appl. No.: 19/069,517

(22) Filed: Mar. 4, 2025

(51) Int. Cl. G06T 15/00; G02B 5/32; G06T 3/60

(52) U.S. Cl. CPC G06T 15/00; G02B 5/32; G06T 3/60

(57) ABSTRACT

In one aspect, a device includes a processor system and storage accessible to the processor system. The storage includes instructions executable by the processor system to dynamically and mechanically actuate a specular holographic display to render holographic three dimensional (3D) images via the display. The display may be controlled in real time using one or more mechanical components inside the display to adjust the appearance of an object represented by the 3D images. In some particular instances, the appearance of the object may be adjusted based on user interaction with the object, such as the user trying to look around the object or the user providing a command to rotate the object.

### FIELD

The disclosure below relates to technically inventive, non-routine solutions that are necessarily rooted in computer technology and that produce concrete technical improvements. In particular, the disclosure below relates to real-time updateable mechanically actuated specular holographic displays.

### BACKGROUND

Stereoscopic displays can present interactable three-dimensional (3D) images to a viewer. But as recognized herein, these displays often leave something to be desired in terms of realistic appearance of the 3D images. There are currently no adequate solutions to the foregoing computer-related, technological problem.

### SUMMARY

Accordingly, in one aspect a device includes a processor system and storage accessible to the processor system. The storage includes instructions executable by the processor system to control a specular holographic display to render a first three dimensional (3D) image. The instructions are also executable to receive a command to present, on the specular holographic display, a second 3D image different from the first 3D image. Responsive to the command, the instructions are executable to actuate at least one component of the specular holographic display to render the second 3D image.

In various non-limiting implementations, the first and second 3D images may be rendered by actuating the at least one component to establish one or more ridges in a display surface of the specular holographic display. Also in various non-limiting examples, the command may be a user command to rotate an object represented by the first 3D image, and here the second 3D image may be a rotated version of the first 3D image. Additionally or alternatively, the command may be generated based on detecting head movement of a viewer.

In one example embodiment, the at least one component may include a plurality of pins. According to this example, the instructions may be executable to actuate the at least one component by moving one or more pins of the plurality of pins in the specular holographic display linearly along respective axes that are each orthogonal to a plane established by a display surface of the specular holographic display.

Also in one example embodiment, the at least one component may include a first arm. According to this example, the instructions may be executable to actuate the at least one component by rotating the first arm about an axis of rotation for a distal end portion of the first arm to move against a display surface of the specular holographic display.

Additionally or alternatively, the at least one component may include a first arm and a second arm different from the first arm. According to this example, the instructions may be executable to actuate the at least one component by rotating the first arm about a first axis of rotation for a distal end portion of the second arm to move against a display surface of the specular holographic display. The second arm may be mechanically linked to the first arm via a coupling that establishes a second axis of rotation between the first and second arms.

What's more, in some instances the at least one component may include a first arm and a magnetic component. According to this example, the instructions may be executable to actuate the at least one component by rotating the first arm about an axis of rotation, resulting in the magnetic component of the first arm to move against a display surface of the specular holographic display. If desired, the magnetic component may include a ball. Also if desired, the magnetic component may be moved against the display surface to establish one or more contours in a substance in the display surface. The substance may be established by a liquid and/or a solid, such as an oil or powder.

Also in one example embodiment, the at least one component may include a first arm, and second arm that is different from the first arm and that has a magnetic component. According to this example, the instructions may be executable to actuate the at least one component by rotating the first arm about a first axis of rotation for the magnetic component of the second arm to move against a display surface of the specular holographic display. The second arm may be different from the first arm, and the second arm may be mechanically linked to the first arm via a coupling that establishes a second axis of rotation between the first and second arms.

In another aspect, a method includes controlling a display to establish first ridges in a reflective surface of the display to render a first three dimensional (3D) image. The method also includes identifying a trigger to present, on the display, a second 3D image different from the first 3D image. Responsive to identifying the trigger, the method then includes controlling the display to remove at least one of the first ridges and to establish second ridges in the reflective surface to render the second 3D image.

In various non-limiting examples, the display may be a specular holographic display.

What's more, in certain example implementations, the method may include establishing the first and second ridges using pins that push into a first side of the reflective surface to form the first and second ridges in a second side of the reflective surface.

Additionally or alternatively, the method may include establishing the first and second ridges by pushing respective distal end portions of respective arms into a first side of the reflective surface to form the first and second ridges in a second side of the reflective surface.

Also in certain example implementations, the method may include establishing the first and second ridges using one or more magnetic components to move a substance in the reflective display surface to form the first and second ridges.

In still another aspect, at least one computer readable storage medium (CRSM) that is not a transitory signal includes instructions executable by a processor system. The instructions are executable by the processor system to actuate a specular holographic display to establish ridges in a reflective surface of the specular holographic display. The ridges establish a three dimensional (3D) image.

In various examples, the instructions may be executable to actuate the specular holographic display via mechanical means to form the ridges in the reflective surface.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a perspective view of an example specular holographic display consistent with present principles;

FIG. 3 is a perspective view showing an example specular holographic display in relation to a light source that emits incident light toward the display consistent with present principles;

FIG. 4 is a schematic illustrating how a virtual holographic point may be created by a curved ridge in a reflective surface of a specular holographic display consistent with present principles;

FIG. 5 illustrates example logic in flow chart format that may be executed by a specular holographic display and/or connected device consistent with present principles;

FIG. 6 shows an exploded side view of a first example embodiment of mechanical components that may be used to actuate a specular holographic display consistent with present principles, with the first example embodiment including pins inside the display that may each be actuated to create ridges in the display's reflective surface to render a 3D holographic image;

FIGS. 7 and 8 show schematics of second and third example embodiments of mechanical components that may be used to actuate a specular holographic display consistent with present principles, with the second and third example embodiments including arms inside the display that may be actuated to create ridges in the display's reflective surface to render a 3D holographic image; and

FIGS. 9 and 10 show schematics of fourth and fifth example embodiments of mechanical components that may be used to actuate a specular holographic display consistent with present principles, with the fourth and fifth example embodiments including magnetic elements inside the display that may be actuated to create ridges in the display's reflective surface to render a 3D holographic image.

### DETAILED DESCRIPTION

Among other things, the detailed description below describes real-time, updateable, mechanically-actuated specular holographic displays that may be used to present true 3D images. This allows for occlusion and “looking around” the 3D image in real life. The displays disclosed herein may therefore be configured via various mechanical components to present autostereoscopic holographic images that are updateable in real-time, allowing the viewer to perceive the true, encoded 3D image even when moving his or her head to “look around” the image. This in turn avoids a break in the holographic illusion that would otherwise be perceived by the viewer as the viewer moves relative to the display. A relatively large viewing angle may therefore be afforded by present principles for adequate perception of the 3D effect of the image being rendered.

Accordingly, an otherwise 2D reflective display surface may exhibit curved engravings or ridges to create a perceived 3D image, using the reflective display surface to reflect light to the viewer's eyes in a way that allows perception of a true 3D image. Because the curves reflect light to each of the viewer's eyes at slightly different angles, the viewer perceives the reflected light glints as “virtual points” in 3D, either above or below the actual display surface. The position of each virtual point can be set to any position in 3D space by controlling the radius and center position of the reflective curve. Many curves can therefore be used to create many 3D virtual points, which may all combine to form a desired 3D virtual image to be seen by a human viewer.

With the foregoing in mind, in one particular aspect, innovative autostereoscopic displays may be both holographic and updateable in real-time. This gives the advantages of both displaying a true 3D image with a wide viewing angle (rather than displaying one or more stereoscopic two dimensional (2D) images) and also enabling the ability to change the image being displayed. To implement this, aspects discussed below provide for the changing of the shape of the display itself instead of simply digitally updating one or more 2D image display screens like liquid crystal displays, light emitting diode displays, etc. Doing so allows the specular holographic image to be updated in real-time, dynamically changing the shape of the reflective display surface on the fly for high-fidelity 3D image rendering as discussed further below.

In terms of the particular mechanical embodiments discussed below, these example embodiments may be used to change the shape of the display in a variety of ways. For example, in one non-limiting embodiment, one or more styluses may be mounted underneath a flexible reflective sheet serving as the display surface. The styluses may press into the reflective sheet to create the curved ridges for specular holography. When the display is to be changed, the flexible sheet can be smoothed either by electrical or mechanical techniques to reset the ridges, and the process may begin again.

As another non-limiting example, a pin board device may be mounted underneath the flexible reflective sheet serving as the display surface. Pins from the board can be mechanically actuated to create the desired ridges in the display surface for specular holography.

As yet another non-limiting example, one or more ferromagnetic spheres may be pushed into the display surface as itself covered with a thick reflective oil (e.g., with flexible, reflective base material). Thus, one or more magnetic actuators may be disposed underneath the display surface and move the spheres to create etchings in the surface, creating the specular holographic effect.

Additionally, in particular non-limiting examples, real-time specular holographic display systems consistent with present principles may include a flexible and reflective material serving as a display screen, one or more mechanical means of deforming the screen, an electrical and/or mechanical component for returning the screen to its original flat shape, a computer system to determine what screen deformations are needed to form a desired specular hologram, and a light source mounted at an angle to the screen to generate specular light glints off the display surface. However, it is to be further understood that ambient front lighting and/or other front lighting may also be used to help create the 3D appearance for the image.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used, as may a Chrome or Android or Windows or macOS or iOS operating system. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single- or multi-chip processor that can execute logic by means of various lines such as address lines, data lines, and control lines and registers and shift registers. Moreover, any logical blocks, modules, and circuits described herein can be implemented or performed with a system processor such as a central processing unit (CPU), a graphics processing unit (GPU), a neural processing unit (NPU), a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in the art. Where employed, the software instructions may also be embodied in a non-transitory device that is being vended and/or provided, and that is not a transitory, propagating signal and/or a signal per se. For instance, the non-transitory device may be or include a hard disk drive, solid state drive, or CD ROM. Flash drives may also be used for storing the instructions. Additionally, the software code instructions may also be downloaded over the Internet (e.g., as part of an application (“app”) or software file). Accordingly, it is to be understood that although a software application for undertaking present principles may be vended with a device such as the system 100 described below, such an application may also be downloaded from a server to a device over a network such as the Internet. An application can also run on a server and associated presentations may be displayed through a browser (and/or through a dedicated companion app) on a client device in communication with the server.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/ or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java®/JavaScript, C# or C++, and can be stored on or transmitted from a computer-readable storage medium such as a hard disk drive (HDD) or solid state drive (SSD), a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

The term “a” or “an” in reference to an entity refers to one or more of that entity. As such, the terms “a” or “an”, “one or more”, and “at least one” can be used interchangeably herein. “A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. The term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

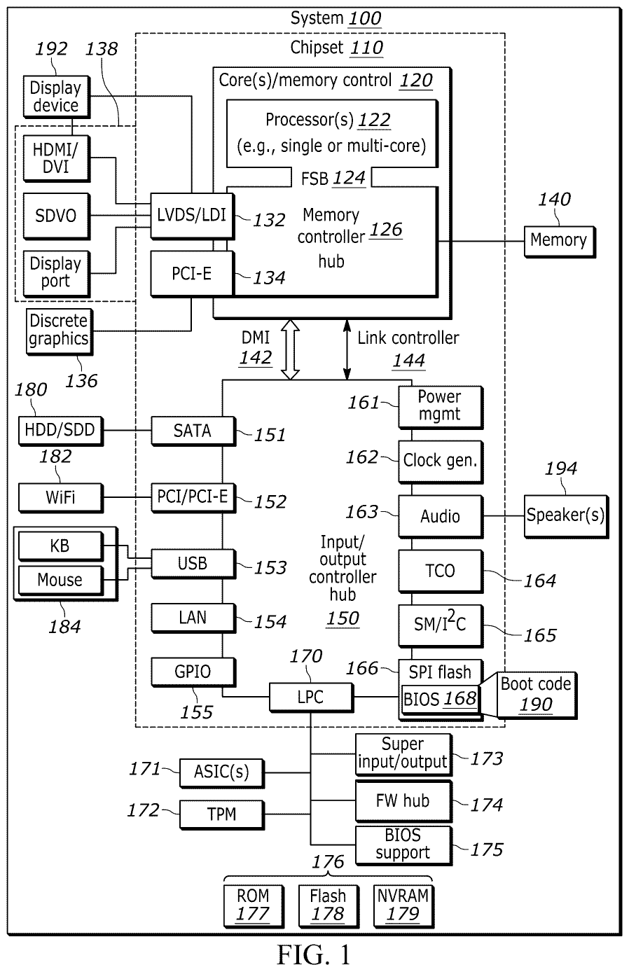

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre®, or notebook computer system, such as ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 includes a processor system 122 (e.g., one or more single core or multi-core processors, etc.) and a memory controller hub 126 that exchange information via a front side bus (FSB) 124. A processor system such as the system 122 may therefore include one or more processors acting independently or in concert with each other to execute an algorithm, whether those processors are in one device or more than one device. Additionally, as described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. For example, the memory controller hub 126 may include a 16-lane (x16) PCI-E port for an external PCI-E-based graphics card (including, e.g., one or more GPUs). An example system may thus include PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface. Example network connections include Wi-Fi as well as wide-area networks (WANs) such as 4G and 5G cellular networks.

The interfaces of the I/O hub controller 150 may provide for communication with various devices, networks, etc. For example, where used, the SATA interface 151 and/or PCI-E interface 152 provide for reading, writing or reading and writing information on one or more drives 180 such as HDDs, SSDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for simplicity, in some embodiments the system 100 may include a gyroscope that senses and/or measures the orientation of the system 100 and provides related input to the processor system 122, an accelerometer that senses acceleration and/or movement of the system 100 and provides related input to the processor system 122, and/or a magnetometer that senses and/or measures directional movement of the system 100 and provides related input to the processor system 122.

Still further, the system 100 may include an audio receiver/microphone that provides input from the microphone to the processor system 122 based on audio that is detected, such as via a user providing audible input to the microphone. The system 100 may also include a camera that gathers one or more images and provides the images and related input (e.g., metadata like an image timestamp) to the processor system 122. The camera may be a thermal imaging camera, an infrared (IR) camera, a digital camera such as a webcam, a three-dimensional (3D) camera, and/or a camera otherwise integrated into the system 100 and controllable by the processor system 122 to gather still images and/or video.

In addition, the system 100 may include a global positioning system (GPS) transceiver that is configured to communicate with satellites to receive/identify geographic position information and provide the geographic position information to the processor system 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network trained through machine learning may thus include an input layer, an output layer, and multiple hidden layers in between that are configured and weighted to make inferences about an appropriate output.

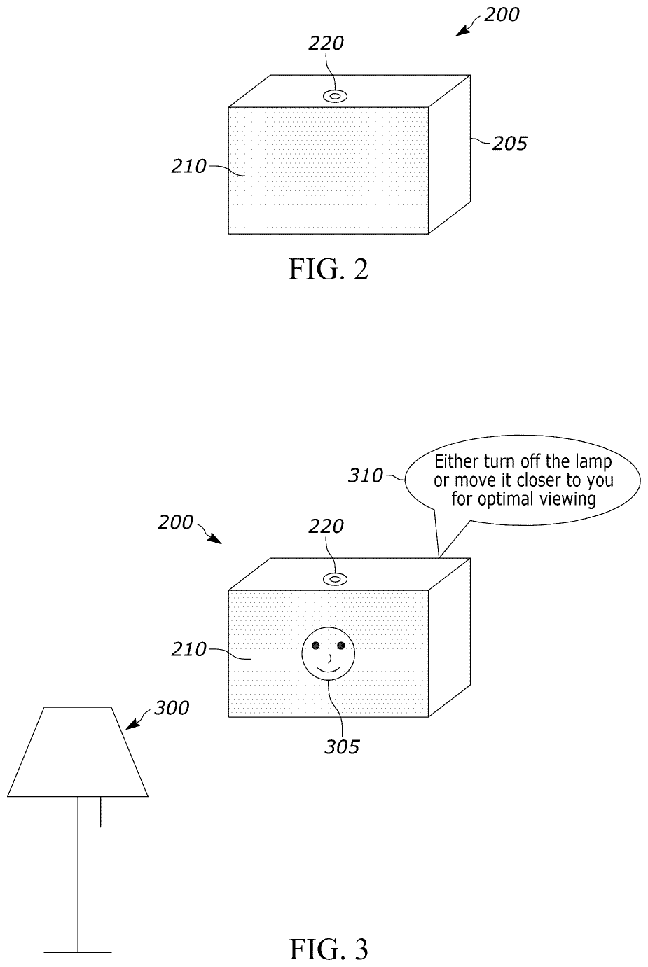

Turning to FIG. 2, this figure shows a perspective view of an example specular holographic display 200 consistent with present principles. The display 200 may include a housing 205 that houses some or all of the components of the system 100 described above. In the example shown, the housing 205 may be a rectangular prism or cuboid, though other shapes may also be used for the housing 205. The housing 205 may be made of a polymer, plastic, or other suitable material.

FIG. 2 also shows a flexible first (e.g., front) surface 210 of the display 200, with the shading for the first surface 210 demonstrating that the outer side of the first surface 210 may be made of/covered with a reflective material. As such, the outer side may be made of mylar, aluminum, and/or another suitable reflective material. Also note that in certain non-limiting embodiments, the outer sides of the other housing surfaces may be both rigid and made of/covered with non-reflective material to reduce the chance of 3D image distortions due to reflections of ambient or acute light off those surfaces. Further note that the reflective surface 210 itself (or at least its outer side) may be biased in a planar or convex in shape. The surface 210 may also be generally flat yet may still be dynamically imprintable with ridges as described in greater detail below to allow for the presentation of different 3D holographic images using the reflective outer side of the surface 210.

As also shown in FIG. 2, the display 200 may include a camera 220. The camera 220 may be controlled by a processor system inside the display 200 or a connected device (e.g., a smartphone wirelessly communicating with the display 200). The camera 220 may be used to identify user commands and track user head movements for changing a 3D presentation of the display accordingly. For example, the user may provide a hand-based gesture command to rotate an object represented by the 3D image(s) being rendered on the display 200, with the display 200 then rotating the object according to the command in response (e.g., by presenting different 3D images showing the object from other angles as rotated versions of the prior 3D image). As another example, the user may physically move his or her head to different positions with respect to the display 200 to inspect the object from different angles, with the display then rotating the object according to the head movement in response to thus show another angle of the 3D object. Other triggers may also be detected using the camera 220 to then alter the appearance of the displayed object in response. Also note here that computer vision and gesture recognition may be used to identify visual commands via the input from the camera 220, with it being further noted that verbal commands as detected via a microphone on the display device 200 may also be used. Keyboard commands, cursor commands, and other types of commands may also be used to trigger a change in 3D images.

Turning to FIG. 3, this figure also shows a perspective view of the display 200. But here, the display 200 is being used to present a holographic 3D “smiley face” 305 via raised ridges in the surface 210.

As also shown in FIG. 3, light from a light source such as a lamp 300 might front-light the surface 210 from a particular angle. With present principles recognizing that the appearance of the holographic image 305 may be adversely affected by light from the acute light source 300 due to the acute light's angle of arrival, the display 200 may use its camera 220 and computer vision to identify the position of the light source 300 with respect to the display 200. Based on the display 200 detecting a suboptimal angle of light from the lamp 300 that causes the virtual points created by the ridges in the reflective surface 210 to be rendered off-center from their intended 3D virtual position according to the user's own viewing angle (also identified using the camera 220 and computer vision/eye tracking), the display may use one of its speakers to present an audible output represented by the speech bubble 310. As shown, the example audible output includes suggestions for optimizing the appearance of the holographic image(s) according to the user's viewing angle, such as “Either turn off the lamp or move the lamp closer to you for optimal viewing.”

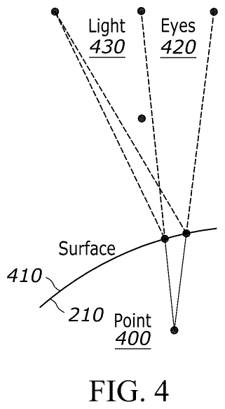

Now in reference to FIG. 4, this figure demonstrates how a virtual point 400 may be created by a curved ridge 410 in the reflective surface 210, thus using specular holography to create a perceived 3D image. The display 200 may therefore implement specular holography using curved ridges on an otherwise 2D surface to reflect light to the viewer's eyes 420 according to the user's viewing angle. Because the curves reflect light to each of the viewer's eyes at slightly different angles, the viewer perceives each of the reflected light glints as a “virtual point” 400 in 3D space, either in front of or behind the actual surface 210 itself. The display 200 can therefore set the position of each virtual point 400 to any desired position in 3D space by controlling the radius and center position of the reflective curve being made in the surface 210. The display 200 may use many different curves in the surface 210 to create many 3D virtual points 400, which may all combine to form a desired 3D virtual image to be seen by the viewer.

FIG. 4 also shows that a light source 430 like the lamp 300 might be directing acute light at the ridge 410 from another angle different from the user's viewing angle. The difference in angles between the light source 430 to the display surface 210 and the eyes 420 to the display surface 210 may be identified by the display 200 to then apply an offset for rendering the point 400 to appear at the intended position in 3D space. This may help with high-fidelity 3D holographic image rendering notwithstanding reflected light from the light source 430. This offset will be described in greater detail below.

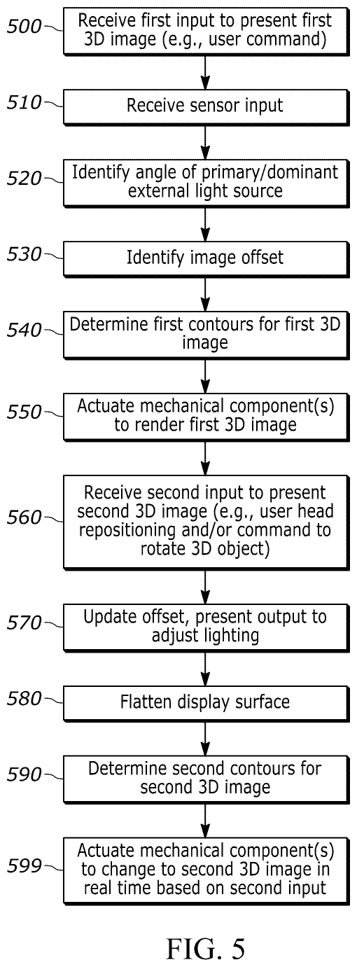

Referring now to FIG. 5, this figure shows example logic that may be executed by a device such as the display 200 and/or a connected device alone or in any appropriate combination consistent with present principles. The connected device might be a server and/or another client device like a smartphone that communicates with the display 200 over a Wi-Fi or other network. Also note that while the logic of FIG. 5 is shown in flow chart format, other suitable logic may also be used.

The logic may begin at block 500 where the display device may receive first input or identify another trigger to present a first 3D image on its specular holographic display. The first input may be a command received from a user, from another device, etc. The logic may then proceed to block 510 where the device may receive sensor input, such as input from the camera 220 as described above. However, further note that other types of optical sensors may also be used.

From block 510 the logic may then proceed to block 520. Here, the device may use the input from the optical sensor to identify both the angle of arrival of light from an acute light source emitting incident light toward the display, and the viewing angle of a viewer toward the display surface. In one particular example, computer vision may be executed at block 520 to make these identifications, through other image processing techniques may also be used.

The logic of FIG. 5 may then continue to block 530. At this step, the device may identify an image offset to apply to optimize rendering of the virtual points to appear at intended locations in 3D space according to the viewer's own viewing angle notwithstanding reflected light from the acute light source. Various machine learning techniques may be used to identify the offset, as well as one or more rules-based algorithms.

For instance, the offset may be determined as one degree of virtual object rotation (as represented in the 3D image) for every ten to twenty degrees of difference between the user's viewing angle and the acute light source angle as identified at block 520. This technique may help compensate for the slight image shift the user might otherwise perceive while also avoiding overcorrection that could also cause an image shift.

From block 530 the logic may then proceed to block 540. Here, the device may determine one or more first contours for a first 3D image that is to be rendered (according to any offset) via ridges in the display surface of the specular holographic display.

After block 540, the logic of FIG. 5 may proceed to block 550. At block 550 the device may control the specular holographic display to render the first 3D image. For example, at block 550 the device may actuate one or more mechanical components to render the first 3D image. Examples of such mechanical components will be discussed in greater detail below. From block 550 the logic may then proceed to block 560.

At block 560 the device may receive second input (or identify another trigger) to present a second 3D image on the specular holographic display. The second 3D image may show the same object as the first 3D image but from a different angle, or may show a different object altogether. The object(s) might be an apple, the globe, a car part, a smiley face, etc.

In instances where the second 3D image shows the same object as the first 3D image but from a different viewing angle, the second input may be a user command to rotate the object itself that is being represented by the images. Additionally or alternatively, the second input may be generated based on head movement of the user (e.g., whether intended as a command or not), which in turn may be interpreted by the device as a trigger to rotate the object in the opposite direction as the head movement itself. Thus, note here that the device may access a stored 3D model of the object to use the vertices indicated in the 3D model to identify corresponding 3D points in space that are to be represented via the specular hologram (depending on the particular angle of view of the object that is to be rendered).

Responsive to receipt of the second input, the logic may then proceed to block 570. Here, the device may update the offset being applied based on any change in the user's viewing angle as compared to the incident light angle of arrival. In certain circumstances, at block 570 the device may also present an output to the viewer akin to the example audible output 310 described above (in addition to or in lieu of applying the updated offset), assisting the user in reducing the image shift themselves.

Also responsive to receipt of the second input, at block 580 the device may withdraw the mechanical components used to make the ridges for the first 3D image from the display surface itself so that the components and surface are no longer in physical contact. The device may then flatten/smooth the display surface to remove any ridges/contours that remain. For example, straps inside the specular holographic display that are connected at each side of the display surface (according to its X-Y plane) may be reeled tight using a motor in the display. This may be done to apply tension to the display surface itself, making it taut and flat to erase the ridges. Then the straps may be released to provide slack for the next 3D image to be rendered on the flexible reflective display surface. Other electrical and mechanical means may also be used to remove the previous ridges and smoothen the display surface.

From block 580 the logic may proceed to block 590. Here, the device may determine one or more second contours for the second 3D image that is to be rendered in the display surface of the specular holographic display (possibly according to the updated offset). The logic may then proceed to block 599 to control the specular holographic display to render the second 3D image according to the user's real-time head movement or according to whatever user command is received.

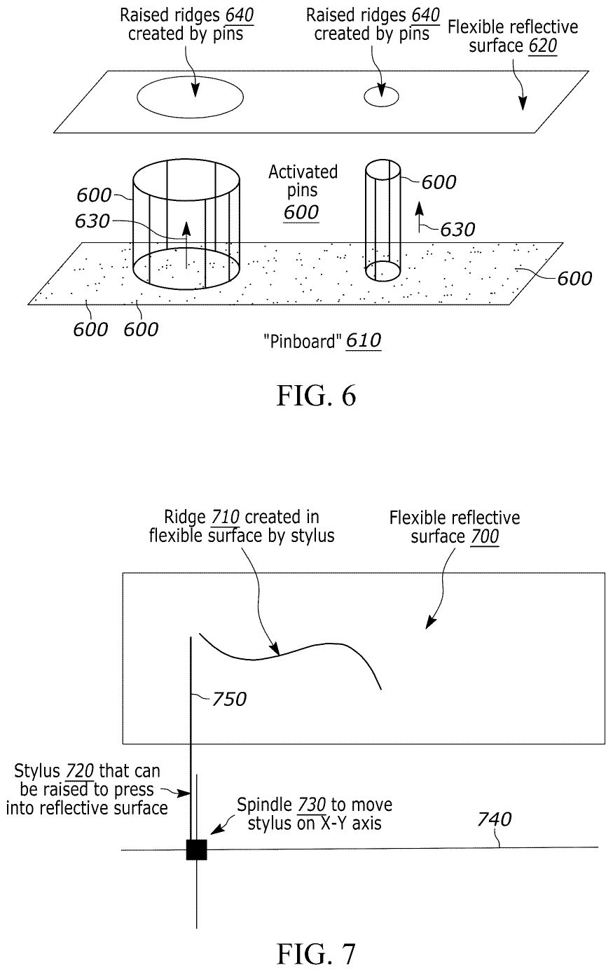

Thus, at both of steps 550 and 590, the device may actuate the one or more mechanical components inside the specular holographic display's housing to make the ridges in the display surface itself to create the relevant 3D image. Various example embodiments for different mechanical components that may be used consistent with present principles will now be described in reference to FIGS. 6-10.

Beginning first with the exploded side view of FIG. 6, this figure shows a first example of how a specular holographic display as described herein may establish ridges in the display's reflective surface to render 3D holographic images. In particular, the display may use a plurality of elongated pins 600 that push into a first (inner) side of the display's reflective surface 620 to form the ridges in the opposite second (outer and visible) side of the reflective surface 620 to present a hologram. The pins 600 may therefore be extended into the first side of the surface 620 under control of a pinboard 610 that is actuated by the display device to individually extend one or more pins 600 from the pinboard 610 toward the inner side of the display surface 620. The pinboard 610 may also be configured to retract the pins 600 away from the surface 620 and back toward the board 610 under control of the display device. Also note that the pins 600 may be arranged on the board 610 in M-by-N grid format as shown in FIG. 6, though other arrangements are also encompassed by present principles.

Additionally, in one particular example, the pinboard 610 may establish an X-Y plane that is parallel to the X-Y plane established by the display surface 620. The pinboard 610 may also include micro-electromechanical system (MEMS) motors and linkage to, under control of the display device's processor, extend and retract the pins 600 linearly along respective axes that are each orthogonal to a plane established by the display surface 620 itself.

To further illustrate present principles, FIG. 6 shows certain pins 600 as having been activated to extend up out of the pinboard 610 and into the first side (inside) of the reflective surface 620, as demonstrated by arrows 630. Also note here that each pin 600 need not be extended into the display surface 620 as the same depth, and that the depths may vary for different image points that are to be presented for different locations in 3D space. The display may thus actuate the pins 600 to physically press into the first (inner) side of the surface 620 at various depths, creating corresponding ridges 640 on the other side of the display surface 620 that extend distally away from the display/surface 620 to form the holographic image. In the present example, certain pins 600 on the pinboard 610 have been raised up to create corresponding circular patterns in the surface 620 so that light reflected off the second (outer) side of the surface 620 creates the intended specular holographic effect.

Continuing the detailed description in reference to the schematic of FIG. 7, this figure shows another example embodiment for implementing specular holography using mechanical components inside the housing of the specular holographic display. In particular, this figure demonstrates that ridges 710 may be established in the flexible reflective display surface 700 by pushing respective distal end portions of respective arms 720 into a first (inner) side of the reflective surface 700 to form the ridges 710 in the second (outer) side of the reflective surface 700. Each arm 720 may be mounted to a spindle 730 that itself is mounted to a board 740 inside the specular holographic display. In non-limiting examples, the board 740 may establish an X-Y plane that is parallel to the X-Y plane established by the surface 700.

Note that only one arm 720 and spindle 730 combination are shown in FIG. 7 for simplicity, but that the board 740 may include many arm/spindle combinations to render a desired holographic image. Also note per the example shown that the arm 720 may be established by a stylus or other elongated element (e.g., pins) that can be raised toward the surface 700 to press into the first (inner) side of the surface 700 to create the ridges 710 that extend away from the other side.

Accordingly, the display may acuate the spindle 730 via a motor inside the display to rotate the arm 720 about an axis of rotation established by the spindle 730 for a distal end portion 750 of the arm 720 to move against the inner side of the display surface 700. It may therefore be appreciated that the spindle may move the arm 720 on an X-Y axis to etch the ridge(s) 710 into the surface 700 according to an X-Y plane established by the surface 700 so that the ridge(s) 710 extend distally away from the surface 700.

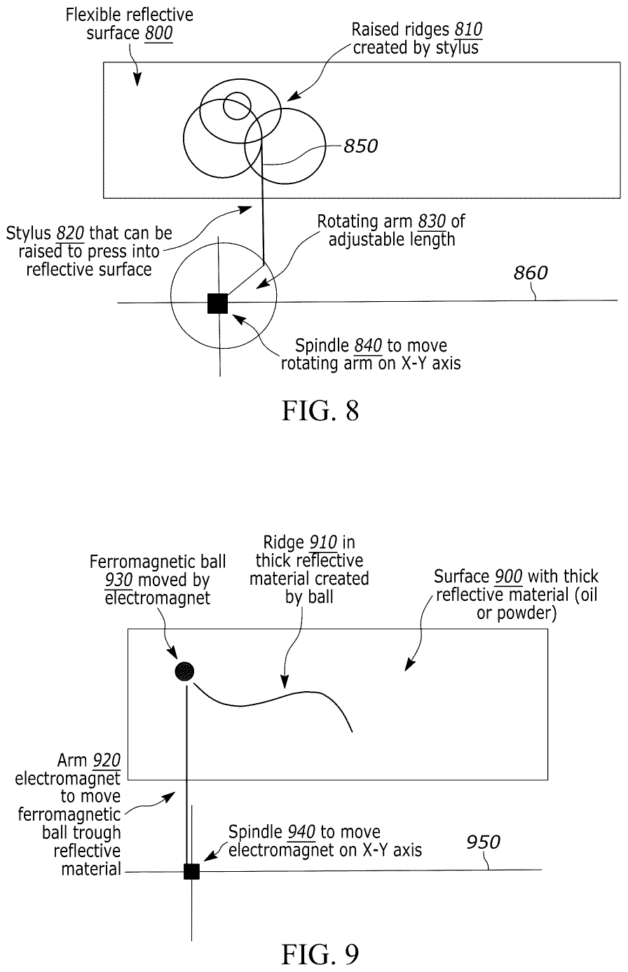

Now in reference to FIG. 8, this figure shows yet another example embodiment for implementing specular holography via mechanical components inside a specular holographic display. This figure also demonstrates that raised ridges 810 may be established in the flexible reflective display surface 800 of the display in the Z-dimension, again by pushing respective distal end portions 850 of respective arms 820 into a first (inner) side of the reflective surface 800 to form the ridges 810 extending away from a second (outer) side of the reflective surface 800. Thus, it is to be understood that the embodiment of FIG. 8 may be similar to the embodiment of FIG. 7, with the following differences being enumerated.

Specifically, per FIG. 8, each arm/spindle combination (only one being shown for simplicity) may include not only a first arm 820 that presses into the first side of the surface 800 but also a second arm 830 of adjustable length. The second arm 830 may be mechanically linked to the first arm 820 via a joint or other coupling. Accordingly, the second arm 830 may be coupled at one end to the first arm 820, and coupled at the opposite end to a spindle 840. Each spindle 840 may be mounted to a board 850 inside the specular holographic display, where the board 850 may establish an X-Y plane that is parallel to the X-Y plane established by the surface 800. It may therefore be appreciated that the spindle 840 may move the rotating second arm 830 about the spindle's X-Y axis of rotation, which in turn rotates the first arm 820 about another axis of rotation established by the coupling between the first and second arms 820, 830.

Additionally, since the arm 830 has an adjustable length, the display 800 may dynamically adjust the length of the second arm 830 using MEMS linkage while rotating the second arm 830 about the first (spindle) axis of rotation. This, in turn, not only rotates the first arm 820 according to the second axis of rotation established by the coupling of the arms 820/830, but also alters the depth at which the distal end portion 850 extends into the display surface 800. The second arm 830 may thus be rotated about the first axis of rotation for the distal end portion 850 of the first arm 820 to move against the inner side of the reflective display surface 800 at varying depths to create holographic points of varying 3D depths. Accordingly, in adjusting the length of the intervening arm 830 between the spindle 840 and arm 820, the ridges 810 may not only be etched into the surface 800 according to the X-Y plane of the surface 800 similar to FIG. 7, but also etched at different depths in the Z dimension under control of the display device. This helps create a corresponding hologram via the ridges 810 extending distally away from the surface 800 at various heights.

FIG. 9 shows a schematic of yet another example embodiment for implementing specular holography using mechanical components inside a specular holographic display consistent with present principles. It is to be understood that that the embodiment of FIG. 9 may be similar to the embodiment of FIG. 7, with the following differences being enumerated.

Specifically, FIG. 9 shows the display establishing ridges 910 in the reflective display surface 900 using one or more magnetic components to move a substance in the reflective display surface 900 to form the ridges 910. Therefore, according to this example, a magnetic (e.g., ferromagnetic) substance may be encased in the surface 900 to establish a relatively thicker surface 900 compared to the other surfaces described above. The magnetic substance may be established by a liquid and/or solid, such as a ferrofluid oil (liquid) and/or powder (solid). Additionally, if desired, the substance itself may be reflective.

The magnetic components of FIG. 9 may also include an arm 920 that is established by or integrated with an electromagnet that is itself controllable by the display device. The electromagnet arm 920 may be coupled to or integral with a magnetic (e.g., ferromagnetic) ball/sphere 930 or other magnetic element located at a distal end portion of the arm 920. Thus, the device may apply electric current to the electromagnet and move the ball 930 against the inner side of the surface 900 using the arm 920 for the magnetic ball 930 to attract the magnetic substance in the surface 900, creating grooves in the substance from the inner side of the surface 900 to establish corresponding ridges 910 on the opposite (outer) side of the surface 900 that extend distally away from the opposite side. If desired, the ball 930 may be made of steel or iron or other suitable material.

For completeness, further note here that similar to FIG. 7, the arm 920 may be rotated about an axis of rotation established by a spindle 940 for the spindle 940 to move the electromagnet arm 920 on an X-Y axis, moving the ball 930 against the display surface 900 to etch the ridge(s) 910 into the surface 900 according to an X-Y plane established by the surface 900 itself. And further note that the spindle 940 may be mounted to a board 950 inside the specular holographic display that, in non-limiting examples, may establish a plane that is parallel to the plane established by the surface 900.

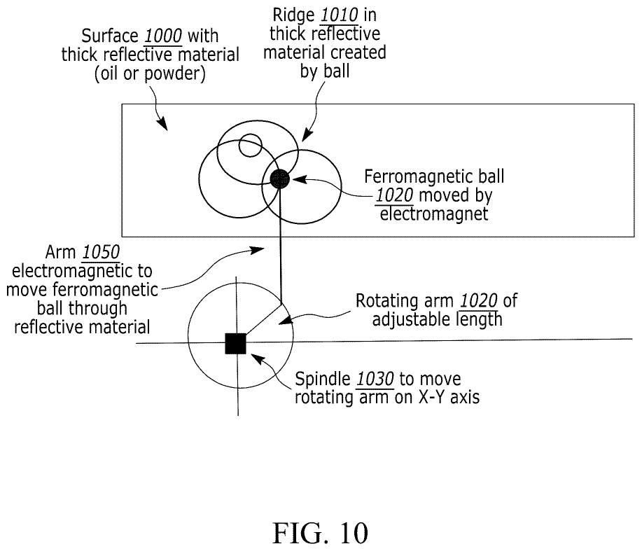

Continuing the detailed description in reference to FIG. 10, this figure shows yet another example embodiment for implementing specular holography using mechanical components inside a specular holographic display consistent with present principles. It is to be understood that that the embodiment of FIG. 10 may be similar to the embodiments of FIGS. 8 and 9, with the following differences being enumerated.

Specifically, the embodiment of FIG. 10 combines the two-arm mechanical embodiment of FIG. 8 with magnetic aspects described above in reference to FIG. 9. As such, the display may rotate a first arm 1020 of adjustable length about a first X-Y axis of rotation established by a spindle 1030 for a magnetic component (e.g., ball) 1040 at a distal end portion of a second arm/electromagnet 1050 to move against the reflective display surface 1000. Additionally, it may be appreciated that here again the second arm 1050 is mechanically linked to the first arm 1020 via a joint or other coupling that establishes a second axis of rotation between the first and second arms 1020, 1050. And owing to the surface 1000 encasing a thick (potentially reflective) magnetic substance like a magnetic oil or powder as described above in reference to FIG. 9, as the ball 1040 presses into and moves through the substance from the inner side of the surface 1000 with current being applied to the electromagnet, the ball 1040 may attract the magnetic substance in the surface 1000 to create grooves in the substance from the inner side to thus establish corresponding ridges 1010 extending distally away from the opposite (outer) side of the display surface 1000.

Furthermore, note that in instances where the substance is itself reflective, the outer sheath of the surface 1000 that encases the substance itself may be translucent and/or transparent. Or as another example, the outer side of the surface 1000 itself may be coated in the reflective substance (e.g., with or without additional substance encased within). Further note that these aspects may similarly be implemented according to the embodiment of FIG. 9.

It may thus be appreciated that, owing to the two-arm embodiment shown in FIG. 10, the rotating arm 1020 may have its length adjusted for ridges 1010 to be created not only in the X-Y plane of the surface 1000 but also at various different depths in the Z dimension to create a desired hologram that includes virtual points at different virtual depths.

It may now be appreciated that present principles provide for an improved computer-based user interface. The disclosed concepts are rooted in computer technology for computers to carry out their functions.

Components included in one embodiment can be used in other embodiments in any appropriate combination. For example, any of the various components described herein and/or depicted in the Figures may be combined, interchanged or excluded from other embodiments.

It is to be understood that whilst present principles have been described with reference to some example embodiments, these are not intended to be limiting, and that various alternative arrangements may be used to implement the subject matter claimed herein. Accordingly, while particular techniques and devices are herein shown and described in detail, it is to be understood that the subject matter which is encompassed by the present application is limited only by the claims.

What is claimed is:

1. A device, comprising:
a processor system; and
storage accessible to the processor system and comprising instructions executable by the processor system to:
control a specular holographic display to render a first three dimensional (3D) image;
receive a command to present, on the specular holographic display, a second 3D image that is different from the first 3D image; and
responsive to the command, actuate at least one component of the specular holographic display to render the second 3D image.

2. The device of claim 1, wherein the first and second 3D images are rendered by actuating the at least one component to establish one or more ridges in a display surface of the specular holographic display.

3. The device of claim 1, wherein the command is a command to rotate an object represented by the first 3D image, and wherein the second 3D image is a rotated version of the first 3D image.

4. The device of claim 1, wherein the command is generated based on detecting head movement of a viewer.

5. The device of claim 1, wherein the at least one component is a plurality of pins, and wherein the instructions are executable to:
actuate the at least one component by moving one or more pins of the plurality of pins in the specular holographic display linearly along respective axes that are each orthogonal to a plane established by a display surface of the specular holographic display.

6. The device of claim 1, wherein the at least one component is a first arm, and wherein the instructions are executable to:
actuate the at least one component by rotating the first arm about an axis of rotation for a distal end portion of the first arm to move against a display surface of the specular holographic display.

7. The device of claim 1, wherein the at least one component includes a first arm and a second arm that is different from the first arm, and wherein the instructions are executable to:
actuate the at least one component by rotating the first arm about a first axis of rotation for a distal end portion of the second arm to move against a display surface of the specular holographic display, the second arm being mechanically linked to the first arm via a coupling that establishes a second axis of rotation between the first and second arms.

8. The device of claim 1, wherein the at least one component includes a first arm and a magnetic component, and wherein the instructions are executable to:
actuate the at least one component by rotating the first arm about an axis of rotation, resulting in the magnetic component of the first arm to move against a display surface of the specular holographic display.

9. The device of claim 8, wherein the magnetic component comprises a ball.

10. The device of claim 8, wherein the magnetic component is moved against the display surface to establish one or more contours in a substance in the display surface.

11. The device of claim 10, wherein the substance is established by a liquid.

12. The device of claim 11, wherein the substance is established by an oil.

13. The device of claim 1, wherein the at least one component includes a first arm and second arm that is different from the first arm and that has a magnetic component, and wherein the instructions are executable to:
actuate the at least one component by rotating the first arm about a first axis of rotation for the magnetic component of the second arm to move against a display surface of the specular holographic display, the second arm being different from the first arm, the second arm being mechanically linked to the first arm via a coupling that establishes a second axis of rotation between the first and second arms.

14. A method, comprising:
controlling a display to establish first ridges in a reflective surface of the display to render a first three dimensional (3D) image;
identifying a trigger to present, on the display, a second 3D image that is different from the first 3D image; and
responsive to identifying the trigger, controlling the display to remove at least one of the first ridges and establish second ridges in the reflective surface to render the second 3D image.

15. The method of claim 14, wherein the display is a specular holographic display.

16. The method of claim 14, comprising:
establishing the first and second ridges using pins that push into a first side of the reflective surface to form the first and second ridges in a second side of the reflective surface.

17. The method of claim 14, comprising:
establishing the first and second ridges by pushing respective distal end portions of respective arms into a first side of the reflective surface to form the first and second ridges in a second side of the reflective surface.

18. The method of claim 14, comprising:
establishing the first and second ridges using one or more magnetic components to move a substance in the reflective display surface to form the first and second ridges.

19. At least one computer readable storage medium (CRSM) that is not a transitory signal, the at least one CRSM comprising instructions executable by a processor system to:
actuate a specular holographic display to establish ridges in a reflective surface of the specular holographic display, the ridges establishing a three dimensional (3D) image.

20. The at least one CRSM of claim 19, wherein the instructions are executable to:
actuate the specular holographic display via mechanical means to form the ridges in the reflective surface.
